(19) United States
(12) Patent Application Publication
(10) Pub. No.: US 2007/0007888 A1
(43) Pub. Date: Jan. 11, 2007

(54) Plasma display panel

(76) Inventor: Sang-Hoon Yim, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/482,459

(22) Filed: Jul. 7, 2006

(30) Foreign Application Priority Data
Jul. 8, 2005 (KR) 10-2005-0061602

(51) Int. Cl. H01J 1/62

(52) U.S. Cl. 313/505

(57) ABSTRACT

A plasma display panel is disclosed. In one embodiment, the plasma display panel includes two opposing substrates, a plurality of discharge cells formed between the substrates, and electrodes. The electrodes include address electrodes, scan electrodes, and sustain electrodes. The address electrodes extend in a first direction. The scan and sustain electrodes extend in a second direction crossing the first direction. Centers of three discharge cells associated with a single pixel together form a triangle. Two of the three discharge cells are driven by a single address electrode.

### CROSS-REFERENCE TO RELATED APPLICATION

This application claims priority to and the benefit of Korean Patent Application No. 10-2005-0061602 filed in the Korean Intellectual Property Office on Jul. 8, 2005, the entire content of which is incorporated herein by reference.

### BACKGROUND OF THE INVENTION

1. Field of the Invention

The present invention relates to a plasma display panel (PDP). More particularly, the present invention relates to a PDP having an enhanced arrangement of pixels and electrodes that enables higher integration of pixels.

2. Description of the Related Technology

Generally, a PDP device excites phosphors with vacuum ultraviolet radiation generated from plasma which is obtained through a gas discharge. The PDP device displays desired images by the use of visible light such as red (R), green (G), and blue (B) colors generated by the excited phosphors.

The PDP has been spotlighted as a flat panel display for TV and industrial purposes with several advantages. The PDP can realize a very large screen size of 60″ or more with a thickness of 10 cm or less. It provides excellent color representation without serious image distortion despite the change of viewing angles, since it is a self emissive display such as a cathode ray tube (CRT). The PDP further provides high productivity and low production costs due to a simplified manufacturing process compared to an LCD.

A three-electrode surface-discharge type of PDP may be taken as an example of a general PDP. The three-electrode surface-discharge type of PDP includes a first substrate and a second substrate spaced apart from the first substrate by a predetermined distance. Sustain and scan electrodes are formed on a surface of the first substrate. Address electrodes are formed on a second substrate so as to extend in a direction to be perpendicular to an extending direction of the sustain and scan electrodes. A discharge gas is filled between the two substrates.

Each PDP discharge cell is selected to be turned on by an address discharge generated between the scan and address electrodes. A sustain discharge, which actually displays a required image, occurs thereafter between the sustain and scan electrodes.

### SUMMARY OF CERTAIN INVENTIVE ASPECTS

One aspect of the present invention provides a plasma display device having a reduced number of address electrodes and thereby minimizing an increase of power consumption for a PDP of higher resolution as well as reducing total circuits cost of the PDP.

In one embodiment, the plasma display device includes i) two opposing substrates between which a plurality of discharge cells are formed, ii) address electrodes formed along a first direction between the substrates and iii) sustain electrodes and scan electrodes formed along a second direction crossing the first direction between the substrates and insulated from the address electrodes, wherein centers of three discharge cells forming a single pixel are arranged in a triangular pattern and two of the three discharge cells are configured to be driven by a single address electrode. 3/2 sustain electrodes may correspond to the pixel where 3/2 scan electrodes correspond. The two discharge cells may have respective phosphor layers of different colors.

The sustain electrodes and the scan electrodes may correspond to the discharge cells as a pair, and the numbers of address electrodes and scan electrodes in a n×n arrangement of pixels may satisfy a ratio of “the number of address electrodes: the number of scan electrodes=4:3. Here, n is a natural number which represents the number of pixels continuously arranged in the first or second direction.

Each of the sustain electrodes and the scan electrodes may include bus electrodes extending in the second direction, and transparent electrodes extending in the second direction and having a width wider than a width of the bus electrodes.

Each of the discharge cells may have a hexagonal or rectangular plan shape.

A borderline between a pair of discharge cells adjacent along the first direction may be formed such that it may cross, when extended, centers of the discharge cells adjacent along the second direction.

In addition, a borderline between a pair of discharge cells adjacent along the first direction may be formed such that it may cross, when extended, a borderline between a pair of another discharge cells adjacent to the pair of discharge cells along the second direction.

The two of three discharge cells forming the pixel may be arranged adjacent to each other in the first direction.

The sustain electrodes and the scan electrodes may be alternately arranged along the first direction.

The centers of the three discharge cells may be arranged as an equilateral triangle.

The centers of the three discharge cells may be arranged as a right triangle. In this case, the sustain electrodes and the scan electrodes may be alternately arranged along the first direction and may correspond to each discharge cell as a pair.

In addition, the sustain electrodes and the scan electrodes may correspond to each discharge cell as a pair, and each pair of sustain and scan electrodes corresponding to adjacent discharge cells along the first direction may be symmetrically arranged with respect to a borderline between the discharge cells adjacent along the first direction.

The respective pixels may include discharge cells of red, green, and blue colors.

Another aspect of the present invention provides a plasma display device includes a plurality of discharge cells three of which form a pixel and a plurality of pixels. A selected single address electrode is configured to address two discharge cells of a selected pixel. The remaining discharge cell may be configured to be driven by another adjacent address electrode. Connecting the centers of the three discharge cell may form a substantially triangle. Another aspect of the present invention provides a method of using a plasma display device including providing a plurality of discharge cells three of which form a pixel providing a plurality of address electrodes and addressing two discharge cells of a selected pixel via a common one of the address electrodes.

### BRIEF DESCRIPTION OF THE DRAWINGS

FIG. 1 is an exploded perspective view of a PDP according to a first exemplary embodiment of the present invention.

FIG. 2 is a top plan view partially showing an arrangement of pixels and electrodes of a PDP according to the FIG. 1 embodiment.

FIG. 3 is a top plan view partially showing an arrangement of pixels and electrodes of a PDP according to a second exemplary embodiment of the present invention.

FIG. 4 is a top plan view partially showing an arrangement of pixels and electrodes of a PDP according to a third exemplary embodiment of the present invention.

FIG. 5 is a top plan view partially showing an arrangement of pixels and electrodes of a PDP according to a fourth exemplary embodiment of the present invention.

FIG. 6 is a top plan view partially showing an arrangement of pixels and electrodes of a typical stripe-type PDP.

FIG. 7 is a top plan view partially showing an arrangement of pixels and electrodes of a typical delta-type PDP.

### DETAILED DESCRIPTION OF CERTAIN INVENTIVE EMBODIMENTS

With reference to the accompanying drawings, embodiments of the present invention will be described in order for those skilled in the art to be able to implement it. As those skilled in the art would realize, the described embodiments may be modified in various different ways, all without departing from the spirit or scope of the present invention. Wherever possible, the same reference numbers will be used throughout the drawing(s) to refer to the same or like parts.

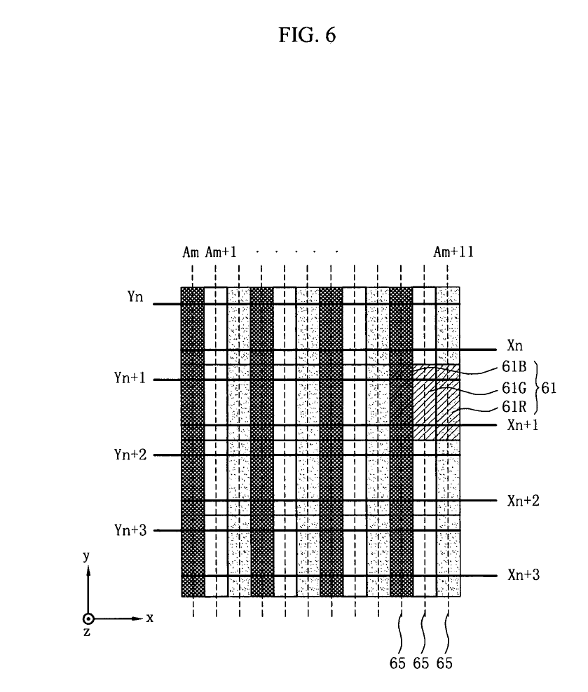

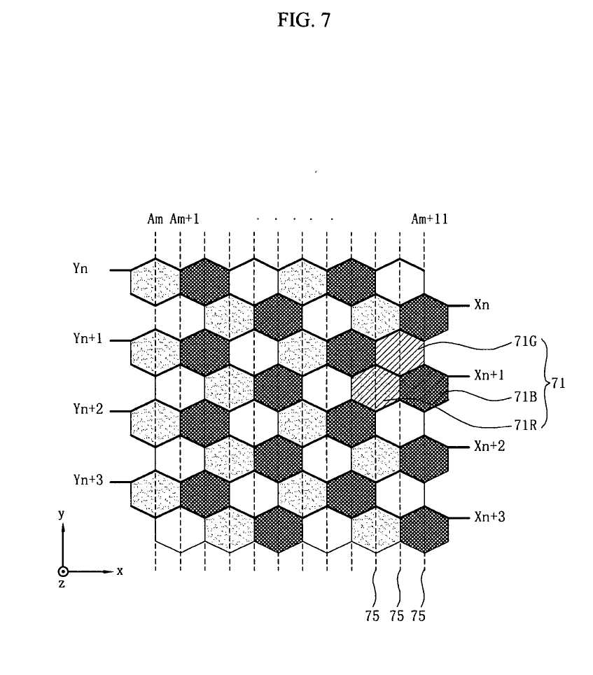

FIG. 6 illustrates a typical stripe structure of barrier ribs of a PDP, and FIG. 7 illustrates a typical delta structure of barrier ribs of a PDP. FIGS. 6 and 7 respectively illustrate only partial views of display areas of PDPs, and thus it should be understood that the respective indices n and m in the drawings may indicate arbitrary integers.

As shown in FIG. 6, discharge cells are defined by i) sustain electrodes (Xn to Xn+3), ii) scan electrodes (Yn to Yn+3) arranged in an x-axis direction and iii) address electrodes (Am to Am+11) arranged in a y-axis direction.

Each pixel 61 includes three adjacent discharge cells 61R, 61G, and 61B of red, green, and blue colors, respectively. Address electrodes 65 pass the discharge cells 61R, 61G, and 61B of the pixel 61.

FIG. 6 shows sixteen pixels formed of twelve address electrodes 65 (Am to Am+11) three of which drive one pixel.

To provide a high resolution PDP, discharge cells are required to be more densely arranged. Accordingly, the distance between adjacent address electrodes 65 becomes closer. However, in this case, capacitance C between the adjacent address electrodes increases resulting in increased energy consumption (which is calculated as CV²f) of the PDP.

In addition, as shown in FIG. 7, in the PDP with the delta-shaped rib structure, a plurality of discharge cells are partitioned by barrier ribs. Each pixel 71 includes three discharge cells 71R, 71G, and 71B of red, green, and blue colors, respectively. The three adjacent discharge cells form a triangular pattern.

Address electrodes 75 pass the discharge cells 71R, 71G, and 71B forming the pixel 71. As illustrated in FIG. 7, twelve address electrodes 75 (Am to Am+11) are used to form sixteen pixels.

Also, in this case, discharge cells are arranged more densely as the resolution of PDPs becomes higher. Since the distance between adjacent address electrodes 75 is closer, capacitance C between the adjacent address electrodes increases. Therefore, energy consumption (which is calculated as CV²f) of the PDP also increases.

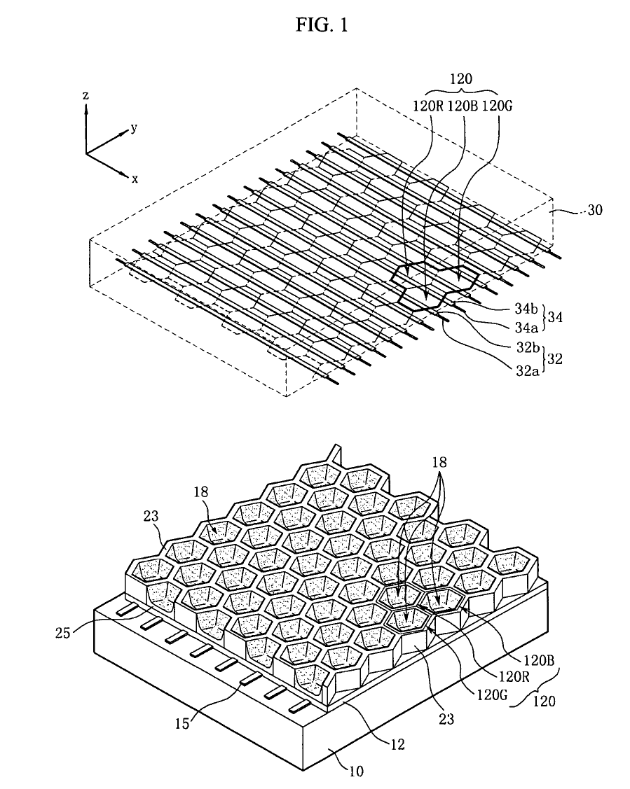

FIG. 1 is an exploded perspective view of a PDP according to a first exemplary embodiment of the present invention.

As shown in the drawings, three subpixels of red, green, and blue colors in each pixel are arranged in a triangular pattern. Furthermore, the PDP includes a rear substrate 10 and a front substrate 30 disposed substantially in parallel and combined together with a predetermined space therebetween. A plurality of discharge cells are partitioned by a plurality of barrier ribs 23 and partitioned pixels 120 are formed between the rear substrate 10 and the front substrate 30.

Each pixel 120 includes three subpixels 120R, 120G, and 120B arranged in the above-mentioned triangular pattern. The subpixels 120R, 120G, and 120B are also partitioned by the barrier ribs 23, and correspond to discharge cells 18.

According to an exemplary embodiment, the cross sections (in an x-axis or y-axis direction) of subpixels 120R, 120G, and 120B are shaped generally hexagonal since the barrier ribs 23 partitioning them are formed in a generally hexagonal or honeycomb pattern. In another embodiment, those cross sections may have other polygonal shapes such as a rectangular shape.

The discharge cells 18 are provided with a plasma gas including, for example, xenon (Xe), neon (Ne), etc, for the plasma discharge. Phosphor layers 25 of red, green, and blue colors are formed in the subpixels 120R, 120G, and 120B of red, green, and blue colors, respectively. Here, the phosphor layers 25 are formed at the bottoms of the discharge cells 18 and lateral sides of the barrier ribs 23.

Address electrodes 15 are formed on the rear substrate 10 to extend along a first direction (y-axis direction in FIG. 1) and are arranged in parallel to one another along a second direction (x-axis direction in FIG. 1). The address electrodes 15 pass underneath the discharge cells 18, more specifically, between the rear substrate 10 and the barrier ribs 23. A dielectric layer 12 covering the address electrodes 15 is formed on the entire surface of the rear substrate 10, and it is also formed below the barrier ribs 23.

Sustain electrodes 32 and scan electrodes 34 are formed on the front substrate 30 to extend along the second direction. The sustain electrodes 32 and the scan electrodes 34 corresponding to respective discharge cells 18 in a pair form a discharge gap in corresponding discharge cells 18. The two electrodes 32 and 34 are alternately arranged along the first direction.

The sustain electrodes 32 and scan electrodes 34 include bus electrodes 32a and 34a and transparent electrodes 32b and 34b, respectively. The bus electrodes 32a and 34a are formed to extend in the second direction. The transparent electrodes 32b and 34b are extended from the bus electrodes 32a and 34a. They have a wider width than that of the bus electrodes 32a and 34a and are formed to extend in the second direction to cover the bus electrodes 32a and 34a.

The bus electrodes 32a and 34a may be formed of a metallic material having good conductivity. In order to minimize blocking the path of visible light generated in the discharge cells 18 during the operation of the PDP, the bus electrodes 32a and 34a may be formed with minimized widths in a range where good conductivity is allowed.

The transparent electrodes 32b and 34b are formed of a transparent material such as indium-tin-oxide (ITO), and are formed to extend in the second direction along with respective bus electrodes 32a and 34a. Therefore, a pair of transparent electrodes 32b and 34b are disposed to face each other in each discharge cell 18 with a predetermined gap therebetween.

A dielectric layer (not shown) covering the sustain electrodes 32 and the scan electrodes 34 may be applied to the entire surface of the front substrate 30, and a protective layer (not shown) formed of, e.g., MgO may be further applied thereon.

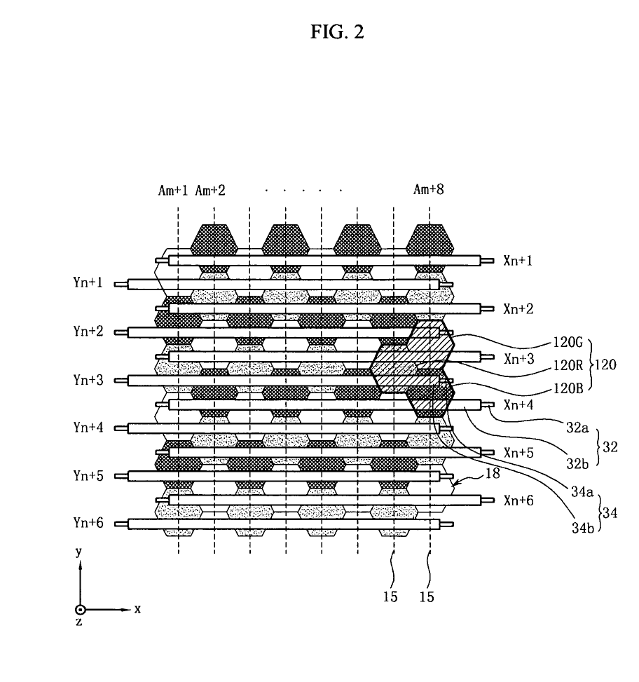

FIG. 2 is a top plan view partially showing an arrangement of pixels and electrodes of a PDP according to a first exemplary embodiment of the present invention.

Referring to FIG. 2, two address electrodes 15 are assigned to each pixel 120. Here, each pixel 120 includes the three subpixels 120R, 120G, and 120B of red, green, and blue colors. In one embodiment, connecting the centers of the subpixels 120R, 120G, and 120B forms generally a triangular pattern. In another embodiment, the centers of the subpixels 120R, 120G, and 120B together form an equilateral triangle. In addition, two of the three discharge cells 18 forming the pixel 120, i.e., two subpixels 120G and 120B, are arranged adjacent to each other in the first direction (y-axis direction in FIG. 2). This arrangement increases discharge spaces in the first direction, thereby forming discharge spaces suitable for discharge. Accordingly, this arrangement provides a wider distance between the address electrodes than that of the typical PDP as exemplified in FIG. 7.

In one embodiment, the two subpixels 120G and 120B of the pixel 120 are driven by the same address electrode 15. In one embodiment, two scan electrodes 34 are assigned to the pixel 120. In this embodiment, the discharge of the three subpixels 120R, 120G, and 120B forming the pixel 120 is determined by two address electrodes 15 and two scan electrodes 34.

In more detail, one of the two address electrodes 15 disposed in each pixel 120 is used to address two discharge cells associated with, for example, two subpixels 120G and 120B. In this embodiment, the other address electrode 15 is arranged to address the remaining discharge cell 18 associated with the subpixel 120R. The two subpixels 120G and 120B may have phosphor layers 25 of different colors.

In one embodiment, one of the two scan electrodes 34 (that is, Yn+3) passes two discharge cells 18 associated with the subpixels 120R and 120B in the x-axis direction. In this embodiment, the other scan electrode (that is, Yn+2) is disposed to cross the remaining discharge cell 18 corresponding to the subpixel 120G. The two discharge cells 18 may have phosphor layers 25 of different colors.

The sustain electrodes 32, e.g., Xn+3 and Xn+4 and the scan electrodes 34, e.g., Yn+3 and Yn+2 may be disposed to cross the pixel 120, respectively. The sustain electrodes 32 and the scan electrodes 34 of a given pixel 120 may be arranged in a different way according to an arrangement of pixels.

In an embodiment, the cross sections of the discharge cells 18 (X-axis or Y-axis direction) have generally a hexagonal shape as shown in FIG. 2.

In one embodiment, the scan electrodes 34 and the sustain electrodes 32 are alternately arranged along the y-axis direction of FIG. 2. A pair of adjacent scan and sustain electrodes are used to produce a display discharge in each based on a voltage applied therebetween.

As shown in FIG. 2, when four columns of pixels 120 are arranged in the x-axis direction and four rows of pixels 120 are arranged in the y-axis direction, six scan electrodes 34 and eight address electrodes 15 are formed to cross a total sixteen pixels 120 (that is, 4×4=16). That is, two address electrodes 15 (that is, 8/4=2) correspond to each pixel 120, and 3/2 scan electrodes 34 (that is, 6/4=3/2) correspond to each pixel 120. Also, 3/2 sustain electrodes 32 correspond to each pixel 120.

In one embodiment, half of the number of the address electrodes is the same as a square root of the total number of the pixels where the number of the pixels adjacent to each other arranged in the y-axis direction is the same as a number of the pixels adjacent to each other arranged in the x-axis direction. In this embodiment, the relationship between the address electrodes 15 and scan electrodes 34 satisfies that a ratio of the number of scan electrodes to the number of address electrodes is 0.75.

Specifically, a total of sixteen pixels 120 are arranged in the 4×4 arrangement since four columns of pixels 120 are arranged in the horizontal direction and four rows of pixels 120 are arranged in the vertical direction. In this case, since two address electrodes 15 correspond to each column of pixels 120, a total of eight address electrodes 15 (Am+1 to Am+8) correspond to all columns of pixels 120 shown in the drawing. In addition, since 3/2 scan electrodes 34 correspond to each row of pixels 120, a total of six scan electrodes 34 (Yn+1 to Yn+6) correspond to all rows of pixels 120 shown in the drawing. Furthermore, a total of six sustain electrodes 32 (Xn+1 to Xn+6) correspond to all rows of pixels 120.

In such an arrangement of pixels, two adjacent subpixels 120G and 120B corresponding to the same address electrode 15 have phosphor layers of different colors. In such a way, subpixels having phosphor layers of the three different colors may be alternately arranged on the same address electrode 15.

One embodiment requires only eight address electrodes to drive sixteen pixels arranged in a matrix pattern of 4×4 whereas a total of twelve address electrodes are required to drive sixteen pixels arranged in a typical matrix pattern as shown in FIGS. 6 and 7. Therefore, the number of address electrodes required to drive the same number of pixels may be reduced.

In addition, a total of six scan electrodes 34 are required to drive sixteen pixels in one embodiment, while a total of four scan electrodes are required in the typical PDPs. Therefore, the number of scan electrodes 34 required to drive the same number of pixels may increase.

That is, the number of address electrodes 15 of the PDP may be reduced by ⅓ in comparison with the number of address electrodes in the typical PDP, thereby simplifying the design of terminals of the address electrodes 15.

In addition, address electrode power consumption may be reduced by ⅓ in comparison with one of the typical PDP. Furthermore, peak power per address element [such as a tape carrier package (TCP), etc.] which controls address electrodes 15 may be reduced by ⅓ compared of the typical PDP of FIGS. 6 and 7. Since scan elements are relatively cheaper than address elements, costs of total circuits to drive a PDP may be reduced even though the number of scan elements increase.

Hereinafter, various exemplary embodiments of the present invention will be explained. Since the various exemplary embodiments of the present invention are similar to the aforementioned exemplary embodiment in structure and operation, difference therebetween will be mainly explained.

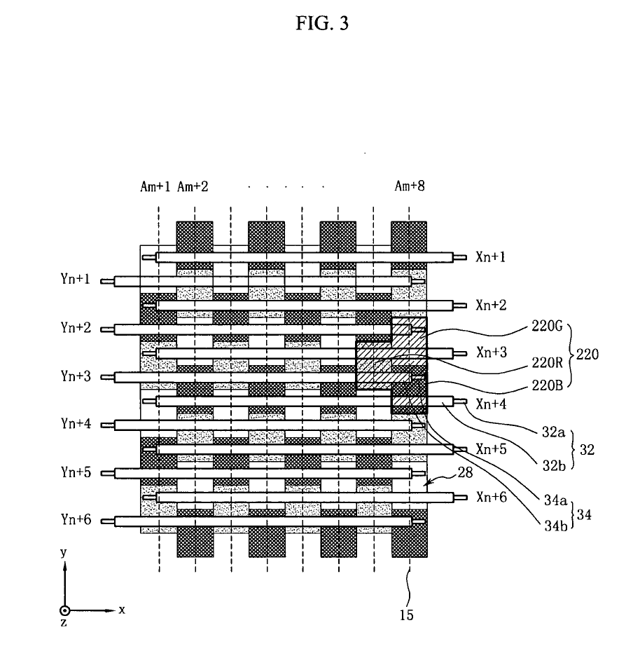

FIG. 3 is a top plan view partially showing an arrangement of pixels and electrodes of a PDP according to a second exemplary embodiment of the present invention.

As shown in FIG. 3, the cross sections of discharge cells 28 including respective subpixels 220R, 220G, and 220B are substantially rectangular. In one embodiment, as shown in FIG. 3, connecting centers of the three subpixels 220R to 220G forms a substantially equilateral triangle.

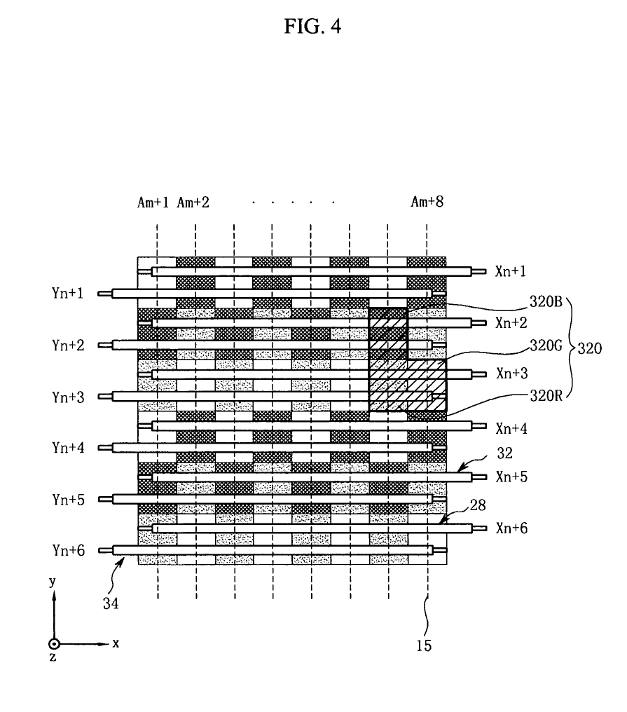

FIG. 4 is a top plan view partially showing an arrangement of pixels and electrodes of a PDP according to a third exemplary embodiment of the present invention.

In one embodiment, connecting centers of the three subpixels 320R, 320G, and 320B form a substantially right triangle.

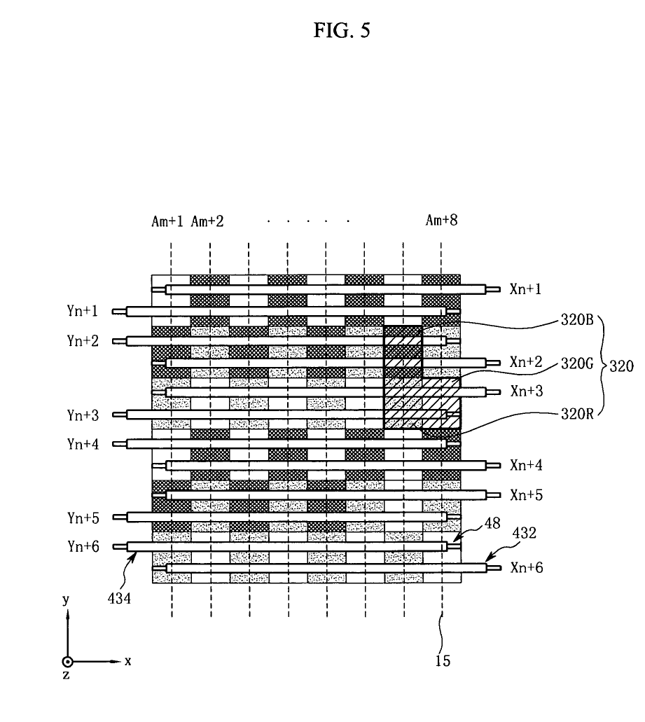

FIG. 5 is a top plan view partially showing an arrangement of pixels and electrodes of a PDP according to a fourth exemplary embodiment of the present invention.

Referring to FIG. 5, the exemplary embodiment is different from the aforementioned exemplary embodiment of FIG. 4 with regard to the arrangement of electrodes. That is, a pair of electrodes include a sustain electrode 432 and a scan electrode 434, and each pair of sustain electrodes 432 and scan electrodes 434 crossing the discharge cells 48 adjacent to each other along the y-axis direction is substantially symmetrically arranged with respect to a borderline between the adjacent discharge cells 48 along the y-axis direction. For instance, the sustain electrodes 432 and scan electrodes 434 crossing a pair of adjacent discharge cells 48 along the first direction may be arranged in the order of the sustain electrode 432, the scan electrode 434, the scan electrode 434, and the sustain electrode 432. In such an arrangement, the number of address electrodes 15 required to drive the same number of pixels may be reduced in comparison with the typical PDPs shown in FIGS. 6 and 7, thereby reducing power consumption.

In the following Table 1, the number of TCPs connected to address electrodes 15, the cost of the TCPs, the number of scan terminals connected to scan electrodes 34, the cost of the scan elements connected to scan electrodes, and the cost of total circuits are compared between an inventive embodiment and typical PDPs.

The inventive embodiment denotes a PDP of a dual driving scheme having a resolution of 1920×1080 (FHD resolution) according to one of the exemplary embodiments discussed above. Comparative Example 1 denotes a PDP of a dual driving scheme having a stripe arrangement of subpixels and achieving the resolution of 1920×1080 (FHD resolution). Comparative Example 2 denotes a PDP of a dual driving scheme having a delta arrangement of subpixels and achieving the resolution of 1920×1080 (FHD resolution).

TABLE 1

| | | | | Cost of | Cost of |
|---|---|---|---|---|---|
| | | | Number of | scan | circuit |
| | Number of | Cost of | address | elements | (relative |
| | TCPs | TCPs (won) | terminals | (won) | value) |
| Inventive | 40 | 320,000 | 1620 | 75,600 | 279,801 |
| Embodiment | | | | | |
| Comparative | 60 | 480,000 | 1080 | 55,020 | 419,188 |
| Example 1 | | | | | |
| Comparative | 60 | 480,000 | 1080 | 55,020 | 319,188 |
| Example 2 | | | | | |

As shown in Table 1, in Comparative Examples 1 and 2, the number of TCPs connected to address electrodes is 60. As the number of TCPs increases, the address power consumption also increases and a distance between adjacent discharge cells becomes shorter. As the distance between adjacent discharge cells become shorter, crosstalk between address electrodes and power consumption increase.

However, in the inventive embodiment, the number of TCPs connected to address electrodes is 40, which is significantly reduced by 20 in comparison with the Examples 1 and 2. Therefore, the PDP according to the inventive embodiment consumes much less address power than the typical PDPs having the same resolution.

In addition, the number of scan terminals connected to scan electrodes 34 in the inventive embodiment increases to 1620 in comparison with 1080 of the two Examples. As the number of scan terminals increases, the number of scan elements also increases.

However, the cost of scan elements is relatively lower than that of TCPs. Accordingly, the cost of the total circuit of the inventive embodiment is relatively lower than that of the Examples 1 and 2.

According to at least one embodiment, two of three subpixels forming a pixel correspond to the same address electrode, and 3/2 scan electrodes correspond to the pixel. Accordingly, the number of address electrodes corresponding to each pixel is reduced and the number of scan electrodes corresponding to each pixel increases, thereby reducing address power consumption for a PDP of higher resolution.

In addition, as the number of address electrodes is reduced, the number of address elements connected to address electrodes is also reduced. Thus, since scan elements are relatively cheaper than address elements, cost of total circuits to drive a PDP may be reduced despite the increased number of scan elements.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display panel, comprising:
two opposing substrates between which a plurality of discharge cells are formed;
address electrodes formed along a first direction between the two substrates; and
sustain electrodes and scan electrodes formed along a second direction crossing the first direction between the substrates,
wherein centers of three discharge cells forming a pixel are together arranged in a substantially triangular pattern,
wherein two of the three discharge cells are configured to be driven by a single address electrode, and
wherein 3/2 scan electrodes correspond to each pixel

2. The plasma display panel of claim 1, wherein the remaining discharge cell is configured to be driven by another adjacent address electrode.

3. The plasma display panel of claim 2, wherein each discharge cell has a phosphor layer formed therein and wherein the three discharge cells have respective phosphor layers of different colors.

4. The plasma display panel of claim 1, wherein two scan electrodes are assigned to the pixel, and wherein one of the two scan electrodes is formed to cross two of the three discharge cells adjacent to each other, and the other is disposed to cross the remaining discharge cell.

5. The plasma display panel of claim 1, wherein two pairs of sustain electrodes and scan electrodes cross the three discharge cells, and
wherein half the number of the address electrodes is the same as the square root of the total number of pixels where the number of pixels adjacent to each other arranged in the first direction is the same as the number of pixels adjacent to each other arranged in the second direction, and
wherein the total number of pixels is associated with the plurality of discharge cells.

6. The plasma display panel of claim 5, wherein the ratio of the number of the scan electrodes to the number of the address electrodes is 0.75.

7. The plasma display panel of claim 1, wherein the sustain and scan electrodes comprise:
bus electrodes; and
transparent electrodes extending from the bus electrodes in the first direction;
wherein the width of each transparent electrode is greater than the width of each bus electrode.

8. The plasma display panel of claim 1, wherein the cross section of each discharge cell in the first or second direction is a substantially hexagonal shape.

9. The plasma display panel of claim 1, wherein the cross section of each discharge cell in the first or second direction is a substantially rectangular shape.

10. The plasma display panel of claim 1, wherein the two of three discharge cells forming the pixel are adjacent to each other in the first direction.

11. The plasma display panel of claim 1, wherein the sustain electrodes and the scan electrodes are alternately arranged along the first direction.

12. The plasma display panel of claim 1, wherein the centers of the three discharge cells together form a generally equilateral triangle.

13. The plasma display panel of claim 1, wherein the centers of the three discharge cells together form a generally right triangle.

14. The plasma display panel of claim 13, wherein the sustain electrodes and the scan electrodes are alternately arranged along the first direction and cross each discharge cell together.

15. The plasma display panel of claim 13, wherein a pair of sustain and scan electrodes are substantially symmetrical to an adjacent pair of sustain and scan electrodes with respect to a borderline shared by the discharge cells which are adjacent to each other along the first direction.

16. The plasma display panel of claim 1, further comprising phosphor layers which are formed in the respective pixel and wherein colors of the phosphor layers are red, green, and blue.

17. A plasma display panel, comprising:
a plurality of discharge cells, three of which form a pixel; and
a plurality of address electrodes,
wherein a selected single address electrode is configured to address two discharge cells of a selected pixel.

18. The plasma display panel of claim 17, wherein the remaining discharge cell is configured to be driven by another adjacent address electrode.

19. The plasma display panel of claim 18, wherein connecting the centers of the three discharge cell forms a substantially triangle.

20. A method of using a plasma display device, comprising:
providing a plurality of discharge cells three of which form a pixel;
providing a plurality of address electrodes; and
addressing two discharge cells of a selected pixel via a common one of the address electrodes.
